(19) United States
(12) Patent Application Publication
(10) Pub. No.: US 2020/0089252 A1
(43) Pub. Date: Mar. 19, 2020

(54) GUIDE ROBOT AND OPERATING METHOD THEREOF

(71) Applicant: LG ELECTRONICS INC., Seoul (KR)

(72) Inventors: Yeonsoo KIM, Seoul (KR); Minjung KIM, Seoul (KR); Beomseong KIM, Seoul (KR); Seungmin BAEK, Seoul (KR); Kwangho AN, Seoul (KR)

(73) Assignee: LG ELECTRONICS INC., Seoul (KR)

(21) Appl. No.: 16/495,270

(22) PCT Filed: Jan. 17, 2018
(86) PCT No.: PCT/KR2018/000818

§ 371 Date: Sep. 18, 2019

(30) Foreign Application Priority Data
Jan. 5, 2018 (KR) 10-2018-0001516

(51) Int. Cl. G05D 1/02; B25J 11/00; G05D 1/12; B25J 9/16; G01S 17/93

(52) U.S. Cl. CPC G05D 1/0246; B25J 11/008; G05D 1/0214; G05D 1/0274; G05D 1/12; G05D 2201/0207; B25J 9/1666; B25J 9/1697; G01S 17/93; G05D 2201/0216; B25J 9/1661

(57) ABSTRACT

An embodiment relates to a guide robot capable of accompanying a user to guide the user to a destination according to a route to a destination, and the robot may include an input unit configured to receive a destination input command, a storage unit configured to store map information, a controller configured to set a route to the destination based on the map information, a driving unit configured to move the robot along the set route, and an image recognition unit configured to recognize an object corresponding to a subject of a guide while the robot moves to the destination, and if the object is located out of the robot's field of view, the controller may control the driving unit so that the robot moves or rotates to allow the object to be within the robot's field of view, and re-recognizes the object.

### TECHNICAL FIELD

Embodiments relate to a guide robot and an operating method thereof.

### BACKGROUND ART

Recently, the functions of robots are expanding due to the development of deep learning technology, autonomous driving technology, automatic control technology, and Internet of things.

Each technology is described in detail in the following. First, deep learning is an area of machine learning. Deep learning is a technology that allows a program to make similar judgments about a variety of situations, not a scheme in which conditions are checked and commands are set in advance. Thus, deep learning allows a computer to think similar to a human brain, and enables vast amounts of data analysis.

Autonomous driving is a technology by which a machine can judge itself and move and avoid obstacles. According to the autonomous driving technology, a robot can recognize the position autonomously through sensors and can move and avoid obstacles.

The automatic control technology refers to a technology that automatically controls the operation of a machine by feeding back measured values about the machine condition to a control device. Therefore, it is possible to control the operation without human manipulation, and to automatically control a target object to be controlled within a target range, that is, to reach the target value.

The Internet of Things (IoT) is an intelligent technology and service that connects all objects based on the Internet and communicates information between people and things and between things and things. Devices connected to the Internet by the IoT communicate with each other without any help from people and communicate autonomously.

The development and convergence of the technologies described above makes it possible to implement intelligent robots and it is possible to provide various information and services through intelligent robots.

For example, a robot can guide a user to a destination according to a route to a destination. The robot can guide the user to the destination according to a route by displaying a map to the destination, or accompany the user to the destination to guide the user according to the route.

Meanwhile, when the robot accompanies the user to the destination to guide the user according to the route, the robot may lose the user on the way to the destination. For example, the robot may fail to recognize the user while rotating or may lose the user by the user's unexpected behavior or when the user is blocked by another person. Accordingly, the robot may fail to guide the user to the destination or it may take a long time to guide the user to the destination.

### DISCLOSURE OF THE INVENTION

### Technical Problem

The present invention provides a guide robot capable of accompanying a user to guide the user to a destination according to a route to a destination without losing the user while guiding the user, and an operating method thereof.

### Technical Solution

A robot according to an embodiment includes: an input unit configured to receive a destination input command; a storage unit configured to store map information; a controller configured to set a route to the destination based on the map information; a driving unit configured to move the robot along the set route; and an image recognition unit configured to recognize an object corresponding to a subject of a guide while the robot moves to the destination, wherein, if the object is located out of the robot's field of view, the controller controls the driving unit so that the robot moves or rotates to allow the object to be within the robot's field of view, and re-recognizes the object.

The image recognition unit may include a camera configured to acquire images around the robot and a RGB (red, green, blue) sensor configured to extract color elements for detecting at least one person from the acquired images.

If the destination input command is received, the controller may control the camera to acquire front image of the input unit and set a person currently inputting a destination in the acquired front image, as the object.

The image recognition unit may further include a lidar configured to sense at least one distance between the robot and at least one person or at least one thing around the robot, and the controller may control the lidar to sense at least one distance between the robot and at least one person around the robot and set a person nearest to the robot as the object.

If the robot fails to recognize the object while setting the object, the controller may set another person included in another acquired image as the object or add the another person as the object.

The image recognition unit may recognize an obstacle while the robot moves to the destination, and the controller may calculate a probability of a collision between the obstacle and the object and reset the route if the probability is equal to or greater than a predetermined value.

The obstacle may include a static obstacle included in the map information and a dynamic obstacle recognized through the image recognition unit.

The controller may calculate an expected path of the obstacle and an expected path of the object and determine whether there is an intersection between the expected path of the obstacle and the expected path of the object to thereby determine whether the obstacle collides with the object.

The controller may determine whether images are blurred based on a number of rotations and angles of the rotations of the robot included in the route.

If it is determined that images are blurred, the controller may change the route to a path which minimizes the number of rotations or reduces angles of the rotations.

### ADVANTAGEOUS EFFECTS

According to an embodiment of the present invention, it is possible to minimize a case where a user is missed while guiding the user who requests guidance to the destination.

According to an embodiment of the present invention, it is possible to more accurately recognize a user requesting guidance through at least one of a RGB sensor, a depth sensor, and a lider, thereby minimizing the problem of guiding a user other than the user having requested guidance to the destination.

According to an embodiment of the present invention, even if a robot fails to recognize a user while guiding the user to the destination, the robot can re-recognize the user through a return motion by rotation or movement and algorithms based on deep learning, to thereby allow the robot to safely guide the user to the destination.

According to an embodiment of the present invention, the occurrence of blurring in an image can be predicted and minimized in advance, thereby minimizing the problem of failing to recognize the user on the way to the destination.

According to an embodiment of the present invention, a user can be guided safely to a destination by minimizing a problem that a user hits an obstacle by predicting the movement of the obstacle and the user which is a subject of guidance.

### BRIEF DESCRIPTION OF THE DRAWINGS

FIG. 1 is an exemplary view showing a robot according to an embodiment of the present invention.

FIG. 2 is a control block diagram of a robot according to a first embodiment of the present invention.

FIG. 3 is a control block diagram of a robot according to a second embodiment of the present invention.

FIG. 4 is a flowchart illustrating a method of operating a robot according to an embodiment of the present invention.

FIG. 5 is an exemplary diagram for explaining a method of setting an object which is a subject of a guide according to a first embodiment of the present invention.

FIG. 6 is an exemplary diagram for explaining a method of setting an object which is a subject of a guide according to a second embodiment of the present invention.

FIG. 7 is an exemplary diagram for explaining a method of changing or adding an object which is a subject of a guide according to an embodiment of the present invention.

FIGS. 8 and 9 are exemplary diagrams for explaining an obstacle according to an embodiment of the present invention.

FIG. 10 is an exemplary diagram for explaining a method of recognizing an object according to an embodiment of the present invention.

FIG. 11 is an exemplary diagram illustrating a method for determining whether an object is included in a field of view of a camera according to a first embodiment of the present invention.

FIG. 12 is an exemplary diagram illustrating a method for determining whether an object is included in a field of view of a camera according to a second embodiment of the present invention.

FIG. 13 is a diagram for explaining a method of re-recognizing an object by a robot according to the present invention.

FIGS. 14 and 15 are diagrams for explaining a method of predicting a route of an object and a dynamic obstacle according to an embodiment of the present invention.

FIG. 16 is a diagram for explaining a method of resetting a route so that a robot according to an embodiment of the present invention minimizes blurring of an image.

### BEST MODE

Hereinafter, specific embodiments of the present invention will be described in detail with reference to the drawings. The same or similar elements are denoted by the same reference numerals regardless of symbols of drawings, and redundant explanations thereof will be omitted. The suffix “module” and “unit” for the components used in the following description are given or mixed in consideration of easy writing, and do not have their own meaning or role. In the following description of the embodiments of the present invention, a detailed description of related arts will be omitted when it is determined that the gist of the embodiments disclosed herein may be blurred. Further, attached drawings are only for the purpose of facilitating understanding of the embodiments disclosed herein, the technical idea disclosed in this specification is not limited by the attached drawings, and it is to be understood that the invention is intended to cover all modifications, equivalents, and alternatives falling within the spirit and scope of the invention.

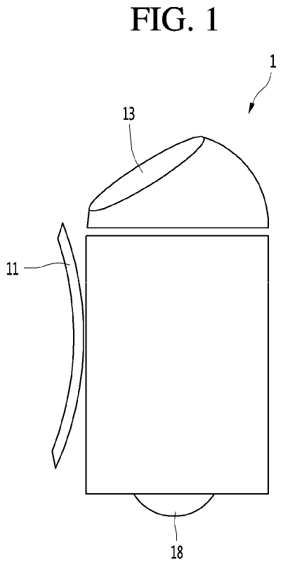

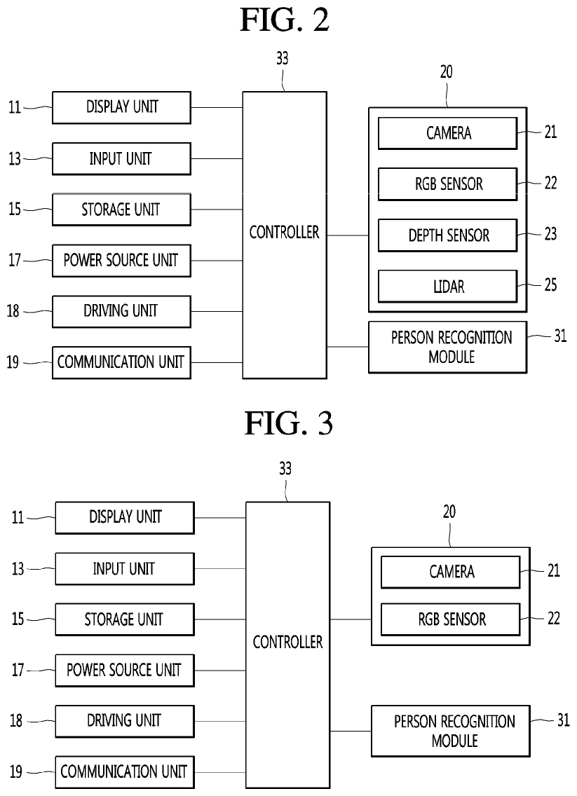

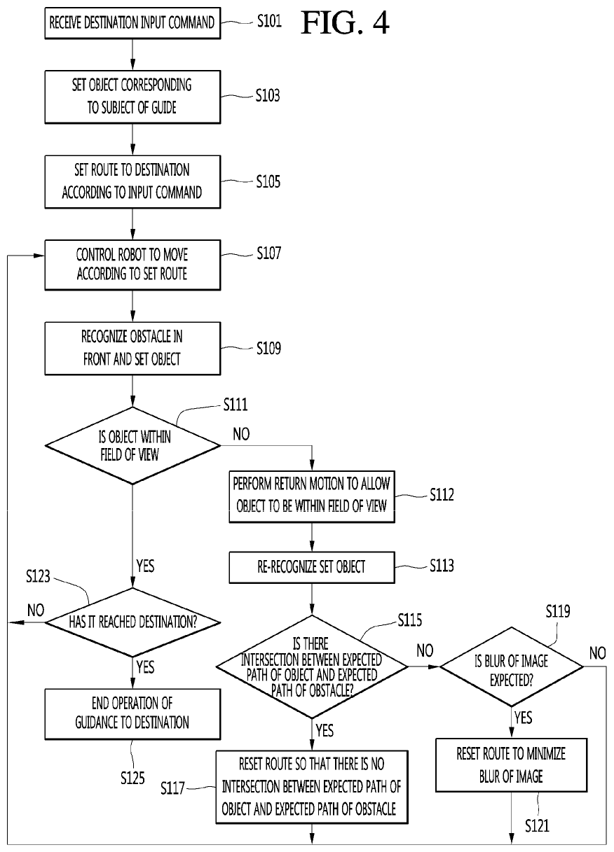

FIG. 1 is an exemplary diagram showing a robot according to an embodiment of the present invention, FIG. 2 is a control block diagram of a robot according to a first embodiment of the present invention, and FIG. 3 is a control block diagram of a robot according to a second embodiment of the present invention.

The robot 1 according to an embodiment of the present invention may include the whole or a part of a display unit 11, an input unit 13, a storage unit 15, a power source unit 17, a driving unit 18, a communication unit 19, an image recognition unit 20, a person recognition module 31, and a controller 33, Alternatively, the robot 1 may further include other components in addition to the components listed above.

Referring to FIG. 1, the robot 1 may include an upper module having an input unit 13 and a lower module having a display unit 11 and a driving unit 18.

The input unit 13 can receive an input command from a user. For example, the input unit 13 may receive an input command for requesting a route guidance, an input command for setting a destination, and the like.

The display unit 11 may display one or more pieces of information. For example, the display unit 11 may display a location of a destination, a route to the destination, an estimated time to the destination, information on one or more obstacles located in front of the destination, etc.

The driving unit 18 can move the robot 1 in all directions. The driving unit 18 can be driven to move the robot along a set route or can be driven to move to a set destination.

The front of the robot 1 may be directed toward a direction in which the input unit 13 is located, and the robot 1 may move forward.

Meanwhile, the upper module provided with the input unit 13 can be rotated in a horizontal direction. When the robot 1 receives a destination input command through the input unit 13, the upper module can be rotated by 180 degrees to be moved forward in a state as shown in FIG. 1, and the user can receive guidance information to the destination while viewing the display unit 11 positioned behind the robot 1. Thus, the robot 1 can guide the user, who is a subject of a guide, to the destination according to a predetermined route.

However, the shape of the robot shown in FIG. 1 is illustrative and need not be limited thereto.

The display unit 11 can display various information. The display unit 11 may display one or more pieces of information necessary for guiding the user to the destination according to the route.

The input unit 13 may receive at least one input command from the user. The input unit 13 may include a touch panel for receiving an input command, and may further include a monitor for displaying output information at the same time.

The storage unit 15 may store data necessary for the operation of the robot 1. For example, the storage unit 15 may store data for calculating the route of the robot 1, data for outputting information to the display unit 11 or the input unit 13, data such as an algorithm for recognizing a person or an object, etc.

When the robot 1 is set to move in a predetermined space, the storage unit 15 may store map information of a predetermined space. For example, when the robot 1 is set to move within an airport, the storage unit 15 may store map information of the airport.

The power source unit 17 can supply power for driving the robot 1. The power source unit 17 can supply power to the display unit 11, the input unit 13, the controller 33, etc.

The power supply unit 17 may include a battery driver and a lithium-ion battery. The battery driver can manage the charging and discharging of the lithium-ion battery, and the lithium-ion battery can supply the power for driving the airport robot. The lithium-ion battery can be configured by connecting two 24V/102A lithium-ion batteries in parallel.

The driving unit 18 may include a motor driver, a wheel motor, and a rotation motor. The motor driver can drive a wheel motor and a rotation motor for driving the robot. The wheel motor can drive a plurality of wheels for driving the robot, and the rotation motor may be driven for left-right rotation or up-down rotation of the main body or head portion of the robot or may be driven for direction change or rotation of wheels of the robot.

The communication unit 19 can transmit and receive data to/from the outside. For example, the communication unit 19 may periodically receive map information to update changes. Further, the communication unit 19 can communicate with the user's mobile terminal.

The image recognition unit 20 may include at least one of a camera 21, an RGB sensor 22, a depth sensor 23, and a lidar 25.

The image recognition unit 20 can detect a person and an object, and can acquire movement information of the detected person and object. The movement information may include a movement direction, a movement speed, and the like.

Particularly, according to the first embodiment of the present invention, the image recognition unit 20 may include all of the camera 21, the RGB sensor 22, the depth sensor 23, and the lidar 25. On the other hand, according to the second embodiment of the present invention, the image recognition unit 20 may include only the camera 21 and the RGB sensor 22. As described above, the components of the image recognition unit 20 may vary depending on the embodiment, and the algorithm for (re)recognizing the objects may be applied differently depending on the configuration of the image recognition unit 20, which will be described later.

The camera 21 can acquire surrounding images. The image recognition unit 20 may include at least one camera 21. For example, the image recognition unit 20 may include a first camera and a second camera. The first camera may be provided in the input unit 13, and the second camera may be provided in the display unit 11. The camera 21 can acquire a two-dimensional image including a person or a thing.

The RGB sensor 22 can extract color components for detecting a person in an image. Specifically, the RGB sensor 22 can extract each of red component, green component, and blue component included in an image. The robot 1 can acquire color data for recognizing a person or an object through the RGB sensor 22.

The depth sensor 23 can detect the depth information of an image. The robot 1 can acquire data for calculating the distance to a person or an object included in an image through the depth sensor 23.

The lidar 25 can measure the distance by measuring the arrival time of a laser beam reflected from a person or object after the laser beam is transmitted. The lidar 25 can acquire data which is generated by sensing the distance to a person or object so as not to hit an obstacle while the robot 1 is moving. In addition, the lidar 25 can recognize surrounding objects in order to recognize the user who is a subject of a guide, and can measure the distance to the recognized objects.

The person recognition module 31 can recognize a person using data acquired through the image recognition unit 20. Specifically, the person recognition module 31 can distinguish the appearance of a person recognized through the image recognition unit 20. Therefore, the robot 1 can identify the user who is the subject of a guide among the at least one person located in the vicinity through the person recognition module 31, and can acquire the position, distance, and the like of the user who is the subject of a guide.

The controller 33 can control the overall operation of the robot 1. The controller 33 can control each of the components constituting the robot 1. Specifically, the controller 33 can control at least one of the display unit 11, the input unit 13, the storage unit 15, the power source unit 17, the driving unit 18, the communication unit 19, the image recognition unit 20, and the person recognition module 31.

Next, a method of operating a robot according to an embodiment of the present invention will be described with reference to FIG. 4. FIG. 4 is a flowchart illustrating a method of operating a robot according to an embodiment of the present invention.

The input unit 13 of the robot 1 can receive a destination input command (S101).

The user can input various information, commands, and the like to the robot 1 through the input unit 13, and the input unit 13 can receive information, commands, and the like from the user.

Specifically, the user can input a command for requesting route guidance through the input unit 13, and input destination information that the user desires to receive. The input unit 13 can receive a route guidance request signal and receive destination information. For example, the input unit 13 is formed of a touch screen, and can receive an input command for selecting a button indicating “route guidance request” displayed on the touch screen. The input unit 13 may receive a command for selecting any one of a plurality of items indicating a destination, or may receive an input command for destination information through a key button indicating an alphabet or a Korean alphabet.

Upon receiving the destination input command, the controller 33 can set an object corresponding to the subject of a guide (S103).

When the robot 1 receives a command for requesting route guidance, the robot 1 can display the route to the destination by a map or accompany the user to the destination according to the route.

If the robot accompanies the user to the destination according to the route, the controller 33 may set the user having requested route guidance as an object corresponding to a subject of a guide in order not to lose the user while guiding the user to the destination.

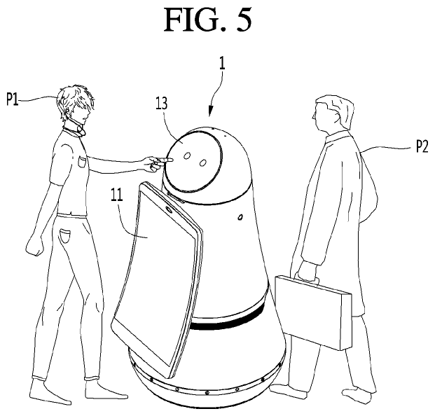

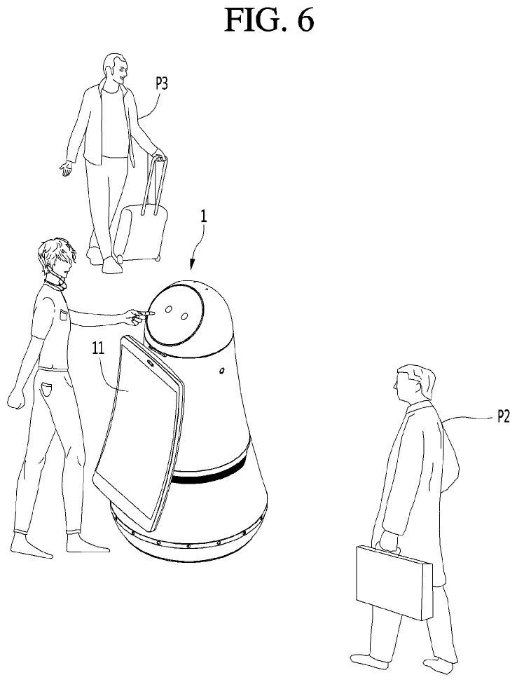

Next, a method of setting an object corresponding to a subject of a guide by the controller 33 according to an embodiment of the present invention will be described with reference to FIGS. 5 and 6.

FIG. 5 is an exemplary diagram for explaining a method of setting an object which is a subject of a guide according to a first embodiment of the present invention, and FIG. 6 is an exemplary diagram for explaining a method of setting an object which is a subject of a guide according to a second embodiment of the present invention.

According to the first embodiment, the controller 33 can set a user, who is inputting information to the input unit 13, as an object that is a subject of a guide when receiving a destination input command. Specifically, referring to FIG. 5, if the controller 33 receives an input command of a destination via the input unit 13, the controller 33 may control the camera 21 to acquire an image including at least one person located in front of the input unit 13. The controller 33 may set at least one person included in the acquired image as the object that is a subject of a guide.

The controller 33 can analyze the acquired image when receiving the destination input command. According to one embodiment, the controller 33 detects at least one person in the image acquired through at least one of the RGB sensor 22 and the depth sensor 23, and detects at least one of the detected persons as an object that is a subject of a guide.

According to another embodiment, the controller 33 can analyze the image acquired by the RGB sensor 22 and the depth sensor 23 and at the same time can detect a person in an adjacent position through the lidar 25, and can set one of the detected persons as an object that is a subject of a guide.

The controller 33 can set at least one of the persons detected in the acquired image as an object that is a subject of a guide.

If the number of persons detected in the acquired image is one, the controller 33 can set the detected one person as an object that is a subject of a guide. If at least two persons are detected in the acquired image, the controller 33 can set only one of the detected two or more persons as an object that is a subject of a guide.

In particular, the controller 33 can determine the person, who currently inputs information to the input unit 13, among the persons detected in the acquired image. Referring to FIG. 5, the controller 33 can control the input unit 13 to detect at least one person located in the area adjacent to the robot 1 when receiving the destination input command. Specifically, the controller 33 may control the camera 21 to analyze the acquired image and detect a person, may control the lidar 25 to shoot a laser beam to detect a person closest to the input unit 13, or may control both the camera 21 and the lidar 25 to detect a person. For example, the controller 33 can detect a first person P1 and a second person P2 and can set the first person P1, who currently inputs information to the input unit 13 among the detected first and second persons P1 and P2, as the object that is a subject of a guide. Referring to FIG. 5, the distance between the robot 1 and the first person P1 may be greater than the distance between the robot 1 and the second person P2, but the controller 33 can set the first person P1, who currently inputs information to the input unit 33, as an object that is a subject of a guide.

According to the first embodiment, the robot 1 has an advantage that the setting of an object that is a subject of a guide can be performed more accurately.

According to the second embodiment, the controller 33 can set a person located closest to the robot 1 as an object that is a subject of a guide when receiving a destination input command.

According to one embodiment, when receiving the destination input command, the controller 33 may control the camera to acquire a surrounding image, control the RGB sensor 22 to detect a person, and control the depth sensor 23 to calculate the distance with the detected person. The controller 33 can set a person having the shortest calculated distance as an object that is a subject of a guide.

According to another embodiment, the controller 33 may control the lidar 25 to detect persons at adjacent positions when receiving a destination input command. The controller 33 may control the lidar 25 to calculate the distance to at least one person adjacent to the robot 1 and set the person having the shortest calculated distance as an object that is a subject of a guide.

According to another embodiment, the controller 33 may detect a person located in the vicinity by using the camera 21 and the lidar 25 together when receiving the destination input command, and may set a person, who is the closest to the robot 1 among the detected persons, as an object that is a subject of a guide.

Referring to an example of FIG. 6, the controller 33 may detect the first to third persons P1, P2, and P3 when receiving the destination input command, and may set the first person P1 having the closest distance from the robot 1, as an object that is a subject of a guide.

According to the second embodiment, the robot 1 can set the object that is the subject of a guide more quickly, and has an advantage that the algorithm for setting the object can be relatively simplified.

According to the third embodiment, the controller 33 can receive the object selection command through the input unit 13 and set the object that is the subject of a guide. The controller 33 can control the camera to acquire a surrounding image with when receiving a destination input command. The controller 33 can output the acquired surrounding image to the display unit 11 or the input unit 13 formed of a touch screen and can receive an object selection command for selecting at least one person from the output image. The user may select a group composed of at least one person including the user himself on the display unit 11 or the input unit 13 formed of a touch screen, and the selected user himself or the group including the user himself may be set to the object that is the subject of a guide.

According to the third embodiment, the robot 1 can enhance the accuracy of the object setting by setting the person selected by the user as the object and provide the user with the function of freely selecting the object that is the subject of a guide.

The controller 33 can set a plurality of persons as objects that are subjects of a guide in the first to third embodiments. For example, in the first embodiment, the controller 33 may detect a person looking at the input unit 13 from the image acquired by the camera 21, and set all of one or more detected persons as the object that is a subject of a guide. In the second embodiment, the controller 33 may calculate the distances from adjacent persons and set the persons located within the reference distance as objects that are subjects of a guide. In the third embodiment, if a plurality of persons is selected, the controller 33 can set all of the persons selected as objects that are subjects of a guide.

However, the above-described methods are merely exemplary and need not be limited thereto.

On the other hand, the controller 33 can detect a state in which it is difficult to recognize the object while setting the object that is the subject of a guide. When the controller 33 detects a state in which it is difficult to recognize the object, the controller 33 can change or add the object that is the subject of a guide.

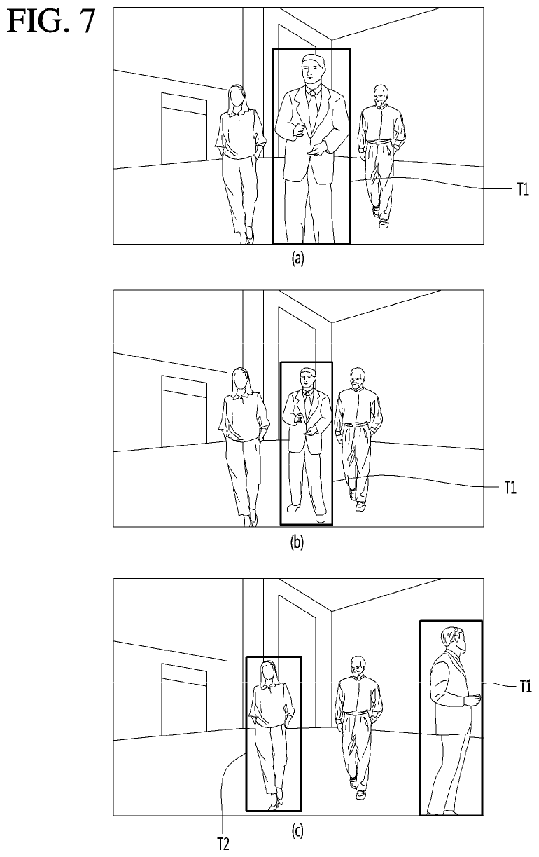

FIG. 7 is an exemplary diagram for explaining a method of changing or adding an object which is a subject of a guide according to an embodiment of the present invention.

In the manner described above, the controller 33 can set the object that is a subject of a guide. For example, as shown in FIG. 7(a), the controller 33 can recognize and set the first target T1 as an object that is a subject of a guide in the image acquired by the camera.

On the other hand, it may take a predetermined time until the controller 33 finishes recognizing and setting the object, and people can move therebetween. For example, as shown in FIG. 7(b), the distance between the robot 1 and the first target T1 may be greater than or equal to the distance between the robot 1 and another person. Further, as shown in FIG. 7(c), the face of the first target T1 may be hidden and the recognition of the object may be impossible. However, the situation shown in FIG. 7 is merely illustrative and may include all the cases that the recognition of the object fails as the first target T1 quickly moves, is hidden by another person, or rotates his head.

In this case, the controller 33 may recognize a person other than the first target T1 as a second target T2 and change the object from the first target T1 to the second target T2 or add the second target T2 as the object. The method by which the controller 33 recognizes the second target T2 may be the same as the method of recognizing the first target T1 and is the same as described above, and thus a detailed description thereof will be omitted.

As described above, according to the embodiment of the present invention, the controller 33 can change or add the object on the way, thereby preventing the case where the recognition and setting of the object fails.

When the setting of the object corresponding to the subject of a guide is completed, the controller 33 can output the image representing the set object to the display unit 11.

Also, the controller 33 may output a message to the display unit 11 to confirm whether the object is correctly set together with the image representing the set object. The user may refer to the object displayed on the display unit 11 and then input a command for resetting the object or a command to start guidance to the destination to the input unit 13. If the command for resetting the object is inputted, the controller 33 may reset the object through at least one of the above-described embodiments, and if the command to start guidance to the destination is received, the controller 33 may start the guidance to the destination while tracking the set object.

Again, FIG. 4 will be described.

The controller 33 can set an object and set a route to a destination according to an input command (S105).

The order of the step of setting the object (S103) and the step of setting the travel path (S105) may be changed, depending on the embodiment.

The storage unit 15 may store map information of a place where the robot 1 is located. Alternatively, the storage unit 15 may store map information of an area where the robot 1 can guide the user according to the route. For example, the robot 1 may be a robot that guides the user in an airport, and in this case, the storage unit 15 may store map information of the airport. However, this is merely exemplary and need not be limited thereto.

The communication unit 19 may include a Global Positioning System (GPS), and may recognize the current position through the GPS.

The controller 33 can acquire a guide path to the destination by using the map information stored in the storage unit 15, the current position recognized through the communication unit 19, and the destination received through the input unit 13.

The controller 33 can acquire a plurality of guide paths. According to one embodiment, the controller 33 can set the guide path having the shortest distance among the plurality of guide paths as the route to the destination. According to another embodiment, the controller 33 can receive congestion information of another zone through the communication unit 19, and can set the guide route having the lowest congestion among the plurality of guide routes to the route to the destination. According to another embodiment, the controller 33 may output a plurality of guide routes to the display unit 11, and then set the guide route selected through the input unit 13 as a route to the destination.

The controller 33 can control the robot 1 to move according to the set route (S107).

The controller 33 can control the robot 1 to move slowly when traveling according to the set route. Specifically, when the route to the destination is set and the robot 1 operates in a guidance mode, the controller 33 may control the robot 1 to move at a first moving speed, and when the robot 1 autonomously moves after the guidance mode is finished, the controller 33 may control the robot 1 to move at a second moving speed. Herein, the first moving speed may be slower than the second moving speed.

The controller 33 can control the robot 1 to recognize the obstacle positioned in the front and the set object (S109).

The controller 33 can control the robot to recognize an obstacle located in front of the robot 1 while moving. On the other hand, the controller 33 can recognize the obstacles in the front and in the periphery of the robot 1.

Here, the obstacle may include both an obstacle obstructing the running of the robot 1 and an obstacle obstructing movement of the set object, and may include a static obstacle and a dynamic obstacle.

An obstacle obstructing the running of the robot 1 is an obstacle whose probability of collision with the robot 1 is higher than a preset reference level. For example, the obstacle obstructing the running of the robot 1 may include a person moving in front of the robot 1 or a thing such as a column located in the route to the destination.

Likewise, an obstacle obstructing the movement of the set object may include an obstacle whose probability of collision with the object is equal to or greater than a preset reference, for example, a person or thing that is likely to be hit in consideration of the route and the moving speed of the object.

The static obstacle may be an obstacle present in a fixed position and may be an obstacle included in the map information stored in the storage unit 15. That is, the static obstacle may be an obstacle that is stored in the map information and may mean an object that is difficult to move the robot 1 or the set object.

The dynamic obstacle may be a person or thing that is currently moving or will move in front of the robot 1. That is, the dynamic obstacle may not be stored as map information or the like but may be an obstacle recognized by the camera 21, the lidar 25 or the like.

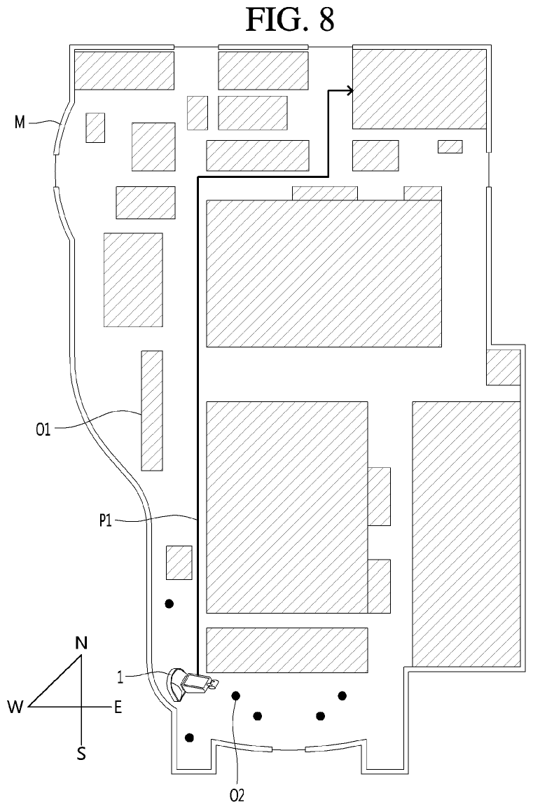

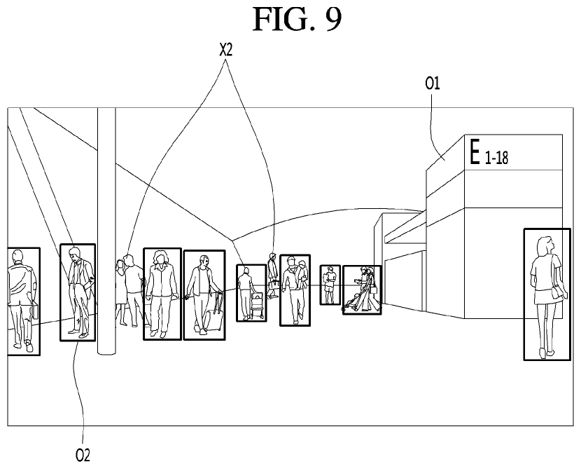

FIGS. 8 to 9 are exemplary diagrams for explaining an obstacle according to an embodiment of the present invention.

Referring to FIG. 8, the controller 33 can set a route to a destination P1 using the map information M. The storage unit 15 may store map information M and the map information M may include information on the static obstacle O1. The controller 33 can recognize the static obstacle O1 stored in the map information M while moving according to the route P1.

In addition, the controller 33 can acquire information about the dynamic obstacle O2 through the image recognition unit 20. Only information on obstacles located within a predetermined distance on the basis of the current location of the robot 1 may be acquired as information on the dynamic obstacles O2. The distance at which the dynamic obstacle can be recognized may vary depending on the performance of each component constituting the image recognition unit 20.

The image shown in FIG. 9 may indicate the recognition result of the static obstacle O1 and the dynamic obstacle O2 in the image acquired by the camera 21, and there may be a person or thing X2 which the robot 1 has failed to recognize. The robot 1 can continue to perform the obstacle recognition operation as shown in FIG. 9 while moving.

Also, the controller 33 can control the robot 1 to recognize the set object while moving.

According to one embodiment, the controller 33 can control the camera to detect a person located in the vicinity by acquiring a surrounding image with the camera 21, and recognize the object by identifying a person who matches the set object among the detected persons. The controller 33 can recognize the object and track the movement of the object.

According to another embodiment, the controller 33 can control the camera to recognize and at the same time, control the lidar 25 to calculate the distance to the object and recognize and track the object.

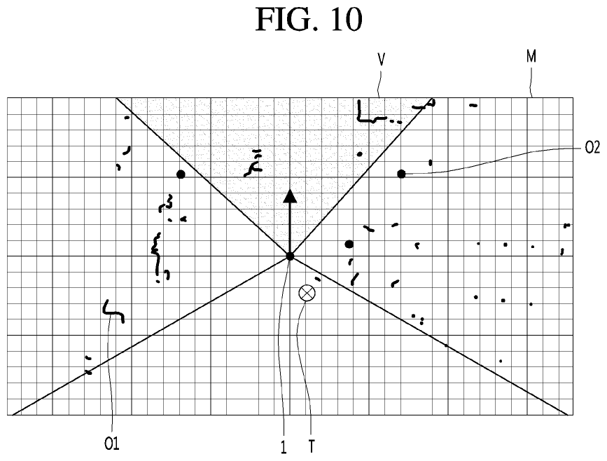

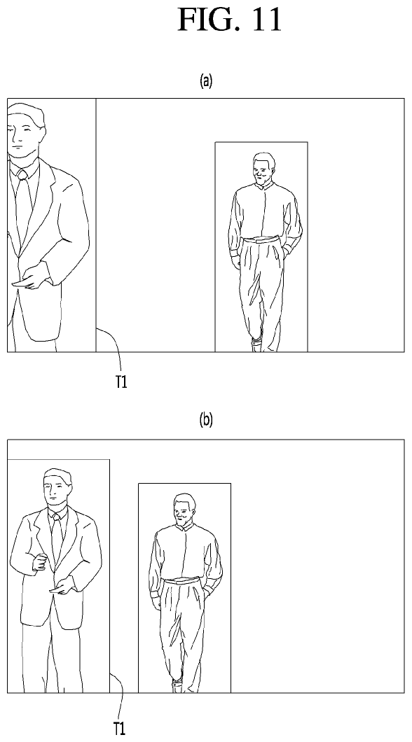

FIG. 10 is an exemplary diagram for explaining a method of recognizing an object according to an embodiment of the present invention.

Referring to FIG. 10, the controller 33 can control the image recognition unit 20 to recognize the static obstacle O1 and the dynamic obstacle O2 based on the map information M. The arrow shown in FIG. 10 may be the moving direction of the robot 1. The field of view V shown in FIG. 10 may represent the field of view of the camera 21. On the other hand, the image recognition unit 20 including the camera 21 is rotatable so that an obstacle can be recognized not only in the moving direction of the robot 1 but also in other directions.

In addition, the controller 33 can control the image recognition unit 20 to recognize the object T positioned in the direction opposite to the moving direction of the robot 1. According to one embodiment, the controller 33 can recognize the object T along with the obstacles O1 and O2 through the rotating camera 21. That is, it is possible to acquire the periphery of the robot 1 with the camera 21 and recognize the object T by identifying the set object among the persons detected in the acquired image.

According to another embodiment, targets detected in an area adjacent to the robot 1 are searched through a rotating lidar 25 or a lidar 25 provided in the direction of the display unit 11, and the object can be set among the searched targets through the image information acquired by the camera 21. The controller 33 can control the lidar 25 to continuously recognize the distance to the set object to thereby track the movement of the object T through the recognized distance information.

The methods of recognizing the obstacles O1 and O2 and the object T may further include methods other than the method described above, or may be implemented in combination.

Again, FIG. 4 will be described.

The controller 33 can determine whether the object is located in the field of view (S111).

If the controller 33 determines that the object is not positioned within the field of view, the controller 33 may perform the return motion so that the object is included in the field of view (S112).

According to one embodiment, the controller 33 can determine whether an object is included in the camera's field-of-view range after positioning the rotating camera 21 in the direction opposite to the moving direction. According to another embodiment, the controller 33 can determine whether an object is included in the field of view of the camera 21 provided in the display unit 11.

Meanwhile, a method of determining whether an object is included in the field of view of the camera 21 by the controller 33 may vary depending on the elements constituting the image recognition unit 20.

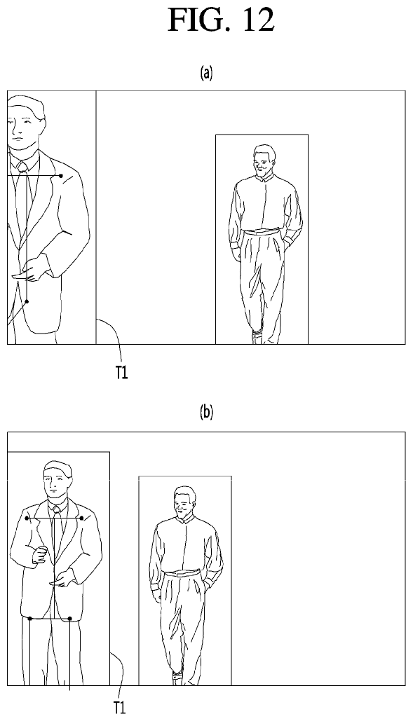

FIG. 11 is an exemplary diagram illustrating a method for determining whether an object is included in a field of view of a camera according to a first embodiment of the present invention, and FIG. 12 is an exemplary diagram illustrating a method for determining whether an object is included in a field of view of a camera according to a second embodiment of the present invention.

First, according to the first embodiment of the present invention, the image recognition unit 20 may include the camera 21, the RGB sensor 22, the depth sensor 23, and the lidar 25. The controller 33 may control the camera 21 to acquire an image in a direction opposite to the moving direction of the robot 1, control the RGB sensor 22 to detect a person, and control the depth sensor 23 to acquire information on the distance between the detected person and the robot 1. Further, the controller 33 can control the lidar 25 to extract the distance to the object.

Accordingly, when setting the object, the controller can control the robot 1 to acquire reference size information through the distance information and the object image, acquire the current size information through the distance information acquired by the lidar 25 when tracking the object and the currently acquired object image, and determine whether the object is not within the field of view of the camera 21 by comparing the reference size information with the current size information. That is, if the difference between the reference size and the current size is equal to or greater than a predetermined value, the controller 33 may determine that the object is out of the field of view of the camera 21. If the difference is less than the predetermined value, the controller 33 may determine that the object is within the field of view of the camera 21. Also, the controller 33 can determine that the object is within the field of view of the camera 21 even if the object is not identified in the acquired image.

In the first embodiment, when it is determined that the object is not located in the field of view of the camera 21, the controller 33 may control the robot 1 to perform a return motion of rotating or moving to allow the object tracked through the lidar 25 to be within the field of view of the camera 21.

As a result, even if the set object T1 is out of the camera's field of view as shown in FIG. 11(a), the object T1 may come to be in the field of view of the camera 21 to thereby minimize the case of losing the object as shown in FIG. 11(b).

According to the second embodiment, the image recognition unit 20 can include only the camera 21 and the RGB sensor 22. In this case, the controller 33 can control the image recognition unit 20 to identify the object in the acquired image to thereby determine whether the object is included in the field of view of the camera 21. For example, the controller 33 may recognize an arm, a waist, a leg, and the like of the object to thereby determine whether the object is included in the field of view of the camera 21. If at least one of the arm, the waist, the leg, and the like is included, the object can be determined to be included in the field of view of the camera 21.

Recognized elements such as an arm, a waist, and a leg of the object are merely illustrative. The controller 33 may set elements for recognizing the object as a default or may set such elements by receiving a user's input command through the input unit 13.

In the second embodiment, when it is determined that the object is not located in the field of view of the camera 21, the controller 33 may control the robot 1 to perform a return motion of rotating or moving by using the moving speed and direction of the object and information on obstacles which have been acquired until then.

For example, the controller 33 may control the robot 1 to perform a return motion so that all the set elements of the object (e.g., an arm, a waist, a leg) are included in the field of view of the camera 21.

As a result, even if the set object T1 is out of the camera's field of view as shown in FIG. 12 (a), the set elements of the object may become included in the field of view of the camera 21 by the return motion as shown in FIG. 12(b).

If the set object is not located in the field of view, the controller 33 can re-recognize the set object (S113).

The controller 33 can rotate the controller 33 or control the driving unit 18 to rotate the robot 1 to thereby acquire images of the surroundings of the robot 1, and the object can be recognized from the acquired images.

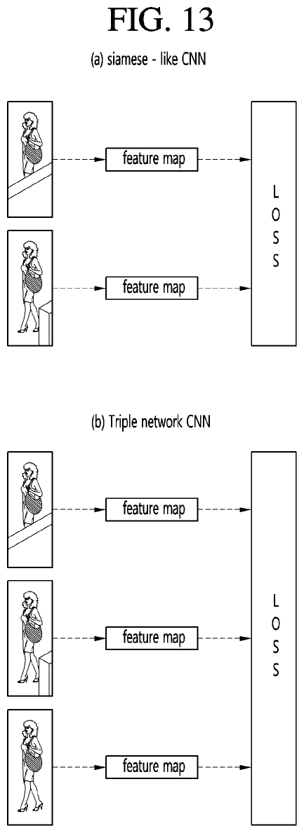

FIG. 13 is a diagram for explaining a method of re-recognizing an object by a robot according to the present invention.

The controller 33 can use a deep learning based matching network algorithm when recognizing an object. The matching network algorithm may extract various data elements such as color, shape, texture, and edge of a person detected in the image, and pass the extracted data to a matching network to thereby acquire a feature vector. The object can be re-recognized by comparing the obtained feature vector with the object which is a subject of a guide and calculating the similarity based on the comparison result. The matching network is a publicly known technology, and thus a detailed description thereof will be omitted.

As shown in FIG. 13(a), the controller 33 may extract two data components from the detected person and apply a matching network algorithm. Alternatively, as shown in FIG. 13(b), the controller 33 may extract three data components from the detected person and apply a matching network algorithm However, this is merely an example, and the controller 33 can extract at least one data component and apply a matching network algorithm.

Again, FIG. 4 will be described.

The controller 33 can determine whether there is an intersection between the expected path of the object and the expected path of the obstacle (S115).

The controller 33 may calculate the possibility of collision between the obstacle and the object, and may control the route to be reset when collision between the obstacle and the object is expected.

Specifically, the controller 33 can acquire the movement information of the object and the movement information of the dynamic obstacle located in the vicinity through the image recognition unit 20, and can obtain the static obstacle information through the map information stored in the storage unit 15.

The controller 33 can expect that the object and the dynamic obstacle will move away from the static obstacle if they face the static obstacle. Therefore, the controller 33 can predict the moving direction and the moving speed of the object, and the moving direction and the moving speed of the dynamic obstacle.

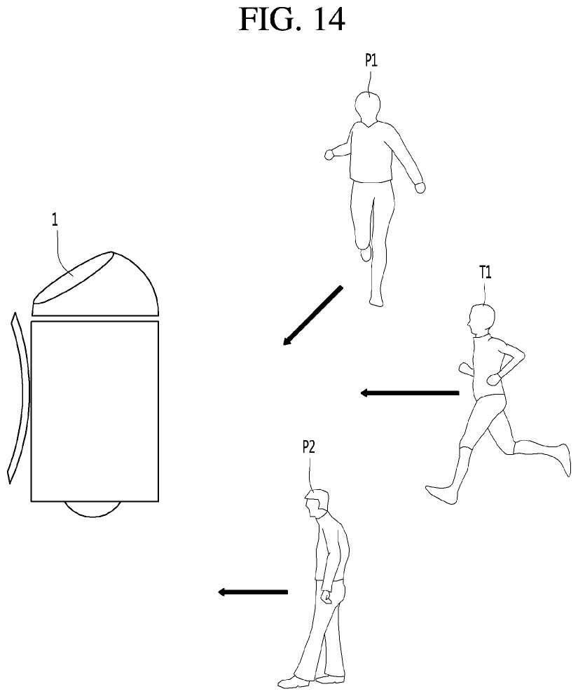

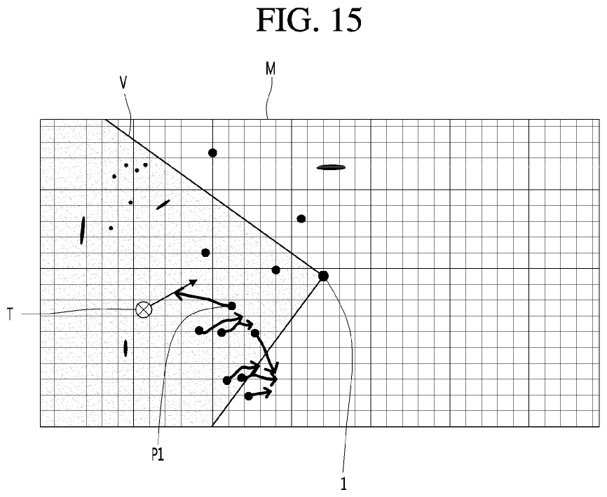

FIGS. 14 and 15 are diagrams for explaining a method of predicting a route of an object and a dynamic obstacle according to an embodiment of the present invention.

The controller 33 can recognize the object T1, the first dynamic obstacle P1 and the second dynamic obstacle P2 which are located around the robot 1. In addition, the controller 33 can predict the moving direction and the moving speed of the object T1, the moving direction and the moving speed of the first dynamic obstacle P1, and the moving direction and the moving speed of the second dynamic obstacle P2.

Referring to the example shown in FIG. 14, it is seen that the moving directions of the object T1 and the first dynamic obstacle P1 coincide with each other. Further, referring to the example of FIG. 15, the arrow indicates a predicted path representing the predicted moving direction and the moving speed of the object or the dynamic obstacle, and it can be determined that there is an intersection between the expected path of the object T1 and the expected path of the first dynamic obstacle P1.

If there is an intersection between the expected path of the object and the expected path of the obstacle, the controller 33 determines that the object and the obstacle are highly likely to collide with each other. If there is no intersection between the expected path of the object and the expected path of the obstacle, the controller 33 determines that the object and the obstacle are not likely to collide with each other.

If there is an intersection between the expected path of the object and the expected path of the obstacle, the controller 33 may reset the route so that there is no intersection between the expected path of the object and the expected path of the obstacle (S117).

For example, the controller 33 may reset the route to the destination so that the object moves away from the expected path of the obstacle by more than a predetermine distance. However, this is merely an example, and the controller 33 can reset the route to the destination by using various methods so that there is no intersection between the expected path of the object and the expected path of the obstacle.

Alternatively, the controller 33 can adjust the movement speed so that there is no intersection between the expected path of the object and the expected path of the obstacle.

Alternatively, the controller 33 may output a warning message indicating “collision expected”, thereby minimizing the possibility that the object collides with the obstacle.

On the other hand, if there is no intersection between the expected path of the object and the expected path of the obstacle, the controller 33 can determine whether blurring of images is expected (S119).

The order of steps 5115 and S119 may be changed.

Blur of an image may mean a state that the image is blurred and thus it is difficult to recognize an object or an obstacle. Blur of an image can occur when the robot rotates, or when a robot, object, or obstacle moves fast.

The controller 33 may predict that a blur of the image may occur when the robot rotates to avoid a static obstacle or a dynamic obstacle. In addition, the controller 33 may predict that image blur will occur if the moving speed of the robot, the object, or the obstacle is equal to or greater than a predetermined reference speed.

Accordingly, the controller 33 can calculate the number of rotations, the rotation angle, the expected moving speed, and the like on the route to thereby to calculate the possibility of image blur.

If the blur of the image is expected, the controller 33 can reset the route so that blur of the image is minimized (S121).

The controller 33 can control to reset the route if the possibility of image blur is equal to or greater than a preset reference.

According to an exemplary embodiment, the controller 33 may calculate the possibility of image blur through the estimated number of blur occurrences of the image compared to the length of the route to the destination. For example, the controller 33 may set the criteria for resetting the route to 10%. If the length of the route is 500 m and the expected number of image blur occurrences is five, the blur occurrence possibility of the image may be calculated as 1%, and in this case, the route may be not changed. On the other hand, if the length of the route is 100 m and the expected number of image blur occurrences is 20, the controller 33 can calculate the blurring probability of the image to be 20%, and in this case, the route may be reset. However, the numerical values exemplified above are merely illustrative for convenience of description and need not be limited thereto.

According to another embodiment, the controller 33 can predict that image blur will occur regardless of the length of the route if the expected number of blur occurrences of the image is equal to or greater than the reference number. For example, the controller 33 may set the criteria for resetting the route to five times. In this case, if the expected number of blur occurrences of the image is 3, the route may not be changed, and if the expected number of blur occurrences of the image is 7 times, the route may be reset. However, the numerical values exemplified above are merely illustrative for convenience of description and need not be limited thereto.

The controller 33 can reset the route to a route that minimizes the number of rotations of the robot 1 or reset the route in a direction that reduces the moving speed of the robot or the object.

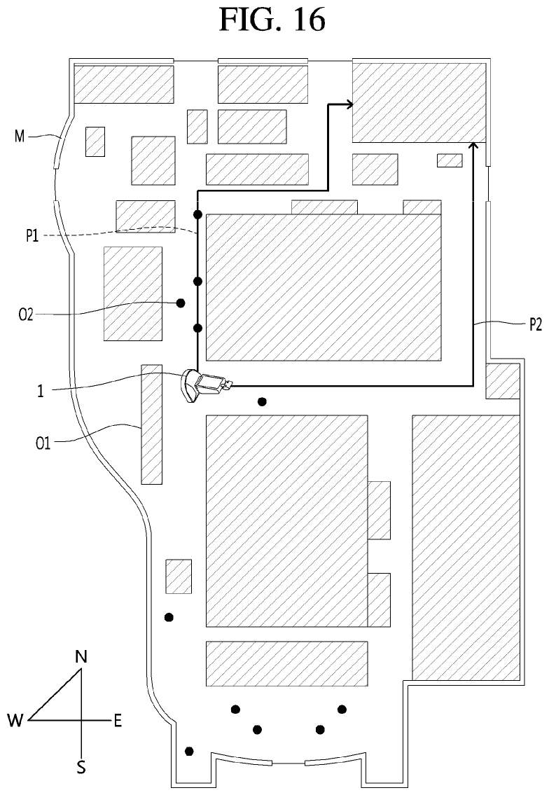

FIG. 16 is a diagram for explaining a method of resetting a route so that a robot according to an embodiment of the present invention minimizes blurring of an image.

Referring to FIG. 16, the robot 1 can recognize an obstacle while moving and can recognize that at least one dynamic obstacle O2 is located on the route P1. Referring to FIG. 16, the controller 33 can expect three rotational movements to avoid three dynamic obstacles O2 located on the route P1, and thus can predict the occurrence of blur.

In this case, the controller 33 can recognize the obstacle according to another guide path, and if it is determined that the possibility of blurring of the image is lower when following the another guide path, the another guide path P2 can be set as the route.

Likewise, if the controller 33 resets the route to minimize the occurrence of image blur, there is an advantage that it is possible to minimize the case where the object is lost.

In FIG. 4, only the method of resetting the route in the direction of minimizing the occurrence of the image blur by predicting the occurrence of the image blur has been described. However, the controller 33 according to the embodiment of the present invention may reset the route so as to minimize the case where the object is obstructed by the obstacle and the recognition of the object fails.

Again, FIG. 4 will be described.

If the route is reset in S117 or S121, the process may return to the step S107 and the robot can be moved according to the reset route.

On the other hand, if the object is located in the field of view at S111, the controller 33 can determine whether the robot 1 has reached the destination (S123).

If the robot 1 has not reached the destination, the process returns to step S107 and the robot can move along the route.

On the other hand, when the robot 1 has reached the destination, the controller 33 can control the robot to end the guiding operation (S125).

In other words, the controller 33 can control the robot 1 end the guiding operation and autonomously move without a destination or return to the original position where the guiding operation was started. However, this is merely exemplary and need not be limited thereto.

According to an embodiment of the present invention, the above-described method can be implemented as a code that can be read by a processor on a medium on which the program is recorded. Examples of the medium that can be read by the processor include ROM, RAM, CD-ROM, magnetic tape, floppy disk, optical data storage, and the like.

The application of the above-described robot is not limited to configurations and methods of the embodiments described above, but the embodiments may be configured such that all or some of the embodiments are selectively combined so that various modifications can be made.

1. A robot comprising:
an input unit configured to receive a destination input command for a destination;
a storage unit configured to store map information;
a controller configured to set a route to the destination based on the map information;
a driving unit configured to move the robot along the set route; and
an image recognition unit configured to recognize an object corresponding to a subject of guidance by the robot while the robot moves to the destination, wherein, when the object is located out of the robot's field of view, the controller controls the driving unit so that the robot moves or rotates to allow the object to be within the robot's field of view, and re-recognizes the object.

2. The robot according to claim 1, wherein the image recognition unit comprises a camera configured to acquire images around the robot and a RGB (red, green, blue) sensor configured to extract color elements for detecting at least one person from the acquired images.

3. The robot according to claim 2, wherein, when the destination input command is received, the controller controls the camera to acquire a front image of the input unit and sets a person in the acquired front image who is currently inputting the destination as the object.

4. The robot according to claim 2, wherein the image recognition unit further comprises a lidar configured to sense at least one distance between the robot and at least one person or at least one thing around the robot, and
wherein the controller controls the lidar to sense the at least one distance between the robot and the at least one person around the robot and sets a person nearest to the robot as the object.

5. The robot according to claim 3, wherein when the robot fails to recognize the object while setting the object, the controller sets another person included in another acquired image as the object or adds the another person as the object.

6. The robot according to claim 1, wherein the image recognition unit recognizes an obstacle while the robot moves to the destination, and
wherein the controller calculates a probability of a collision between the obstacle and the object and resets the set route when the probability is equal to or greater than a predetermined value.

7. The robot according to claim 6, wherein the obstacle comprises a static obstacle included in the map information and a dynamic obstacle recognized through the image recognition unit.

8. The robot according to claim 6, wherein the controller calculates an expected path of the obstacle and an expected path of the object and determines whether there is an intersection between the expected path of the obstacle and the expected path of the object to thereby determine whether the obstacle will collide with the object.

9. The robot according to claim 1, wherein the controller determines whether images are blurred based on a number of rotations and angles of the rotations of the robot while along the set route.

10. The robot according to claim 9, wherein, when it is determined that images are blurred, the controller changes the set route to a path which minimizes the number of rotations or reduces angles of the rotations.

11. The robot according to claim 4, wherein when the robot fails to recognize the object while setting the object, the controller sets another person included in another acquired image as the object or adds the another person as the object.

12. A robot comprising:
an input configured to receive a destination input command for a destination;
a data storage configured to store map information;
a controller configured to set a route to the destination based on the map information;
a motor configured to move the robot along the set route; and
a sensor configured to recognize an object corresponding to a subject of guidance by the robot while the robot moves to the destination,
wherein, when the object is located in a field of view of the robot, the controller controls the motor to continue on the set route and when the object is located out of the field of view of the robot, the controller controls the motor to move or rotate the robot to have the object come back within the field of view of the robot.

13. The robot according to claim 12, wherein the controller is configured to re-recognize the object when the object comes back within the field of view of the robot.

14. The robot according to claim 12, wherein the sensor comprises at least one of a camera configured to acquire images around the robot and a RGB (red, green, blue) sensor configured to extract color elements for detecting at least one person from the acquired images.

15. The robot according to claim 14, wherein, when the destination input command is received, the controller controls the camera to acquire a front image of the input and sets a person in the acquired front image who is currently inputting the destination as the object.

16. The robot according to claim 14, wherein the sensor further comprises a lidar configured to sense at least one distance between the robot and at least one person or at least one thing around the robot, and
wherein the controller controls the lidar to sense the at least one distance between the robot and the at least one person around the robot and sets a person nearest to the robot as the object.

17. The robot according to claim 15, wherein when the robot fails to recognize the object while setting the object, the controller sets another person included in another acquired image as the object or adds the another person as the object.

18. The robot according to claim 12, wherein the sensor recognizes an obstacle while the robot moves to the destination, and
wherein the controller calculates a probability of a collision between the obstacle and the object and resets the set route when the probability is equal to or greater than a predetermined value.

19. The robot according to claim 18, wherein the controller calculates an expected path to the obstacle and an expected path of the object and determines whether there is an intersection between the expected path to the obstacle and the expected path of the object to thereby determine whether the obstacle will collide with the object.

20. The robot according to claim 12, wherein the controller determines whether images are blurred based on a number of rotations and angles of the rotations of the robot while along the set route, and
wherein, when it is determined that images are blurred, the controller changes the set route to a path which minimizes the number of rotations or reduces angles of the rotations.
